(19) United States
(12) Patent Application Publication
(10) Pub. No.: US 2008/0010252 A1
(43) Pub. Date: Jan. 10, 2008

(54) BOOKMARKS AND RANKING

(75) Inventors: Oren Zamir, Los Altos, CA (US); Jeffrey Korn, New York, NY (US)

Correspondence Address: HARRITY SNYDER, LLP, 11350 Random Hills Road, SUITE 600, FAIRFAX, VA, 22030, US

(73) Assignee: Google, Inc., Mountain View, CA (US)

(21) Appl. No.: 11/536,923

(22) Filed: Sep. 29, 2006

Related U.S. Application Data
(63) Continuation-in-part of application No. 11/327,644, filed on Jan. 9, 2006.

(51) Int. Cl. G06F 17/30

(52) U.S. Cl. 707/3

(57) ABSTRACT

A system receives bookmarks associated with one or more documents or sites. The system searches a corpus of documents to obtain search results and ranks the search results using the received bookmarks.

### RELATED APPLICATION

The present application is a continuation-in-part of U.S. application Ser. No. 11/327,644 (Attorney Docket No. 0026-0194), entitled “Server Bookmarks” and filed Jan. 9, 2006, the disclosure of which is incorporated by reference herein in its entirety.

### BACKGROUND

1. Field of the Invention

Implementations described herein relate generally to document browsing and, more particularly, to using bookmarks used for document browsing in ranking search results.

2. Description of Related Art

The World Wide Web (“web”) contains a vast amount of information. Locating a desired portion of the information, however, can be challenging. This problem is compounded because the amount of information on the web and the number of new users inexperienced at web searching are growing rapidly.

Search engines attempt to return hyperlinks to web pages in which a user is interested. Generally, search engines base their determination of the user's interest on search terms (called a search query) entered by the user. The goal of the search engine is to provide links to high quality, relevant results (e.g., web pages) to the user based on the search query. Typically, the search engine accomplishes this by matching the terms in the search query to a corpus of pre-stored web pages. Web pages that contain the user's search terms are “hits” and are returned to the user as links. Each “hit” may be ranked by the search engine based on various factors, such as, for example, the relevance of the “hit” to the search query.

“Bookmarks” or “favorites” are typical ways for a browser executed at a client to remember documents (e.g., web pages) that a user has visited when browsing documents located on a network, such as, for example, the Internet. For example, bookmarks or favorites may be used by a user to remember search results obtained from the execution of a search by a search engine. Bookmarks or favorites permit the user to return to the bookmarked document easily.

### SUMMARY

According to one aspect, a method may include receiving bookmarks associated with one or more documents or sites and searching a corpus of documents to obtain search results. The method may further include ranking the search results using the received bookmarks.

According to another aspect, a method may include receiving bookmarks associated with one or more documents or sites and receiving user input defining how or if the bookmarks are to effect search results. The method may further include searching a corpus of documents to obtain search results and ranking the search results using the bookmarks based on the user input.

According to a further aspect, a method may include obtaining a user's bookmarks, wherein the bookmarks identify documents associated with the user and executing a search based on a first search query received from the user to obtain search results. The method may further include ranking the search results and re-ranking the search results using the user's bookmarks.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 is an exemplary diagram of an overview of an implementation of the invention;

FIG. 2 is an exemplary diagram of a network in which systems and methods consistent with principles of the invention may be implemented;

FIG. 3 is an exemplary diagram of a client or server of FIG. 2 according to an implementation consistent with principles of the invention;

FIG. 4 is a diagram of an exemplary toolbar that includes bookmarks of documents browsed or selected by a user consistent with principles of the invention;

FIGS. 5-8 are diagrams of the use of the exemplary toolbar of FIG. 4 for user specification of how and if bookmarks may be used in ranking search results consistent with principles of the invention;

FIG. 9 is a diagram of exemplary bookmark records stored at a server consistent with principles of the invention;

FIG. 10 is a flowchart of an exemplary process for ranking search results using user bookmarks consistent with principles of the invention; and

FIG. 11 is a diagram illustrating the use of bookmarks in ranking search results consistent with principles of the invention.

### DETAILED DESCRIPTION

The following detailed description of the invention refers to the accompanying drawings. The same reference numbers in different drawings may identify the same or similar elements. Also, the following detailed description does not limit the invention.

Consistent with aspects of the invention, documents selected or browsed by a user may be “bookmarked,” using the user's browser, such that the user can easily return to the bookmarked documents. The bookmarked documents may then be selectively used in ranking search results that result from a search query issued by the user. For each of a user's bookmarks, the user may specify how and if each document bookmark should be used when ranking the user's search results. Thus, in some implementations, documents corresponding to a user's bookmarks may be ranked higher within a set of search results than un-bookmarked documents in the set of search results.

A “document,” as the term is used herein, is to be broadly interpreted to include any machine-readable and machine-storable work product. A document may include, for example, an e-mail, a website, a business listing, a file, a combination of files, one or more files with embedded links to other files, a news group posting, a blog, a web advertisement, a digital map, etc. In the context of the Internet, a common document is a web page. Documents often include textual information and may include embedded information (such as meta information, images, hyperlinks, etc.) and/or embedded instructions (such as Javascript, etc.). A “link” as the term is used herein, is to be broadly interpreted to include any reference to/from a document from/to another document or another part of the same document.

### Overview

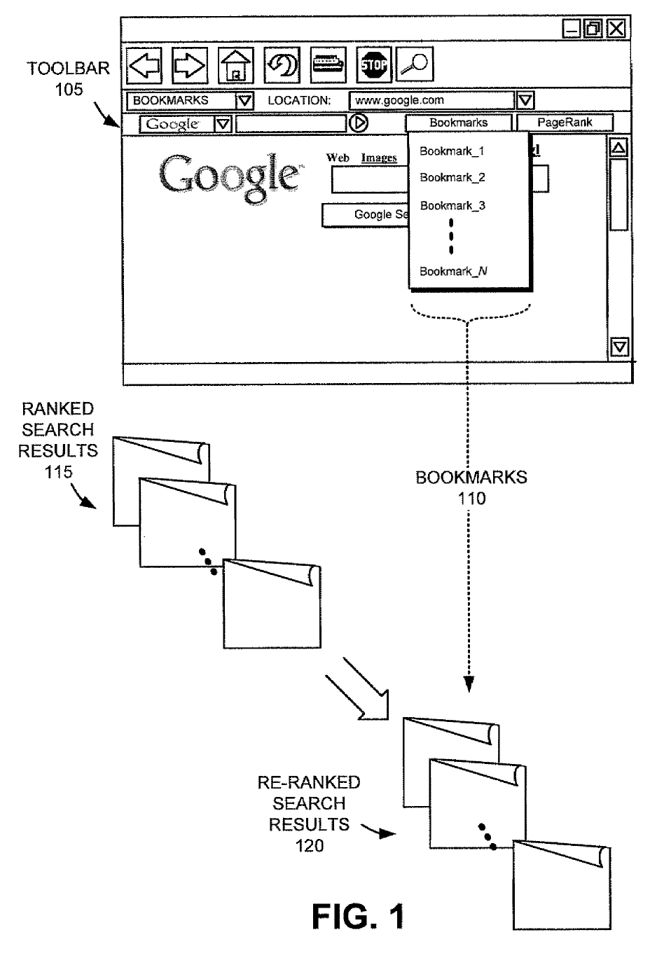

FIG. 1 illustrates an exemplary overview of an implementation of the invention that ranks search results based on a user's bookmarks. A user using a toolbar 105 at a client (not shown) may browse multiple different documents (not shown) via a browser and, among the browsed documents, may select one or more documents to be “bookmarked” for future access and browsing. Each of the document bookmarks 110 may be sent by toolbar 105 to a remote server (not shown) for storage. The user may additionally specify how and if each document bookmark 110 may be used when ranking search results.

The user may subsequently send a search query to the server to execute a search of a corpus of documents (e.g., web pages, images, products and/or services, music, videos). The server may execute the search, using existing document searching techniques, to return a set of search results. The set of search results may include documents that are relevant to the search query sent by the user. Using existing ranking techniques, the server may rank the search results to, for example, put them in order from “most” relevant to “least” relevant, thus, producing ranked search results 115. The server may then access the user's stored bookmarks and, possibly, the user indications of how and if each document bookmark 110 should be used when ranking search results. The server may use bookmarks 110, and the user indications of how and if each document bookmark 110 should be used, in re-ranking the search results to produce re-ranked search results 120. The user's bookmarks 110, thus, may be selectively used in promoting corresponding documents in ranked search results 115.

### Exemplary Network Configuration

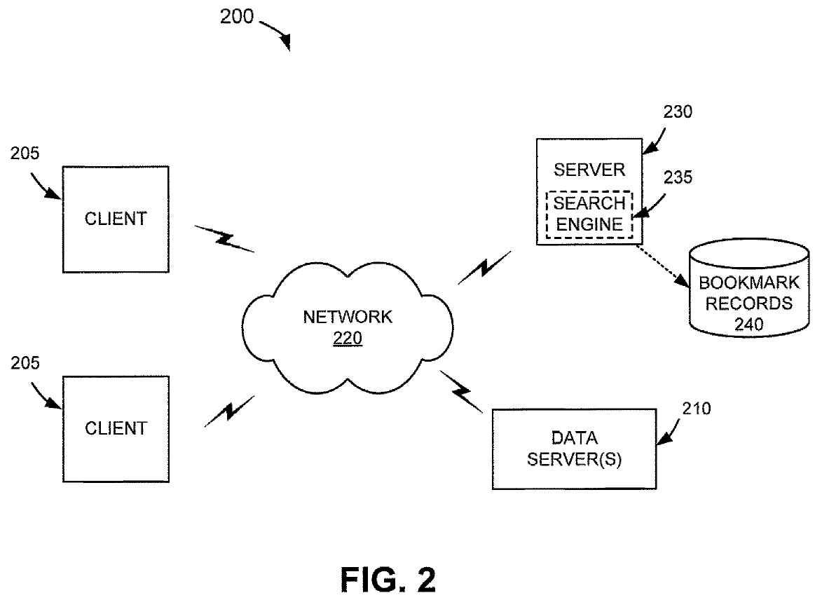

FIG. 2 is an exemplary diagram of a network 200 in which systems and methods consistent with the principles of the invention may be implemented. Network 200 may include multiple clients 205 connected to one or more servers 210 or 230 via a network 220. Two clients 205 and two servers 210 and 230 have been illustrated as connected to network 220 for simplicity. In practice, there may be more or fewer clients and servers. Also, in some instances, a client may perform one or more functions of a server and a server may perform one or more functions of a client.

Clients 205 may include client entities. An entity may be defined as a device, such as a personal computer, a wireless telephone, a personal digital assistant (PDA), a lap top, or another type of computation or communication device, a thread or process running on one of these devices, and/or an object executable by one of these devices. Clients 205 may implement a browser for browsing documents stored at servers 210 or 230, the browser including a toolbar 105 that includes bookmark functionality, as further described in detail below. Servers 210 and 230 may include server entities that access, fetch, aggregate, process, search, and/or maintain documents in a manner consistent with the principles of the invention Clients 205 and servers 210 and 230 may connect to network 220 via wired, wireless, and/or optical connections.

In an implementation consistent with the principles of the invention, server 230 may include a search engine 235 usable by users at clients 205. Server 230 may implement a data aggregation service by crawling a corpus of documents (e.g., web pages) hosted on data server(s) 210, indexing the documents, and storing information associated with these documents in a repository of crawled documents. The aggregation service may be implemented in other ways, such as by agreement with the operator(s) of data server(s) 210 to distribute their documents via the data aggregation service. Search engine 235 may execute a search using a query, received from a user at a client 205, on the corpus of documents stored in the repository of crawled documents. Server 230 may provide, to a user issuing a query, a ranked list of documents related to the issued query. Server 230 may also store bookmarks, received from respective users at clients 205, in bookmarks records 240. The stored bookmarks may subsequently be retrieved by server 230 for use in ranking search results for respective users.

Data server(s) 210 may store or maintain documents that may be crawled by server 230. Such documents may include data related to published news stories, products and/or services, images, user groups, geographic areas, music, videos, or any other type of data. For example, server(s) 210 may store or maintain news stories from any type of news source, such as, for example, the Washington Post, the New York Times, Time magazine, or Newsweek. As another example, server(s) 210 may store or maintain data related to specific products, such as product data provided by one or more product manufacturers. As yet another example, server(s) 210 may store or maintain data related to other types of web documents, such as pages of web sites.

While servers 210 and 230 are shown as separate entities, it may be possible for one of servers 210 or 230 to perform one or more of the functions of the other one of servers 210 or 230. For example, it may be possible that servers 210 and 230 are implemented as a single server. It may also be possible for a single one of servers 210 and 230 to be implemented as two or more separate (and possibly distributed) devices.

Network 220 may include one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The PLMN(s) may further include a packet-switched sub-network, such as, for example, General Packet Radio Service (GPRS), Cellular Digital Packet Data (CDPD), or Mobile IP sub-network.

### Exemplary Client/Server Architecture

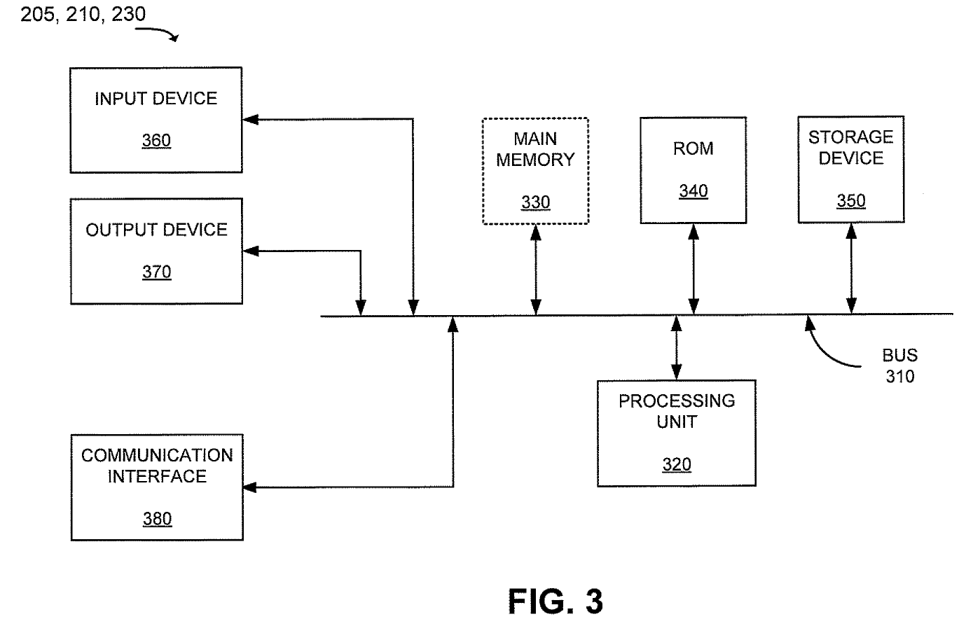

FIG. 3 is an exemplary diagram of a client or server entity (hereinafter called “client/server entity”), which may correspond to one or more of clients 205 and/or servers 210 or 230, according to an implementation consistent with the principles of the invention. The client/server entity may include a bus 310, a processor 320, a main memory 330, a read only memory (ROM) 340, a storage device 350, an input device 360, an output device 370, and a communication interface 380. Bus 310 may include a path that permits communication among the elements of the client/server entity.

Processor 320 may include a processor, microprocessor, or processing logic that may interpret and execute instructions. Main memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive.

Input device 360 may include a mechanism that permits an operator to input information to the client/server entity, such as a keyboard, a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that enables the client/server entity to communicate with other devices and/or systems. For example, communication interface 380 may include mechanisms for communicating with another device or system via a network, such as network 240.

The client/server entity, consistent with the principles of the invention, may perform certain operations or processes, as will be described in detail below. The client/server entity may perform these operations in response to processor 320 executing software instructions contained in a computer-readable medium, such as memory 330. A computer-readable medium may be defined as a physical or logical memory device and/or carrier wave.

The software instructions may be read into memory 330 from another computer-readable medium, such as data storage device 350, or from another device via communication interface 380. The software instructions contained in memory 330 may cause processor 320 to perform operations or processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

### Exemplary Client Toolbar

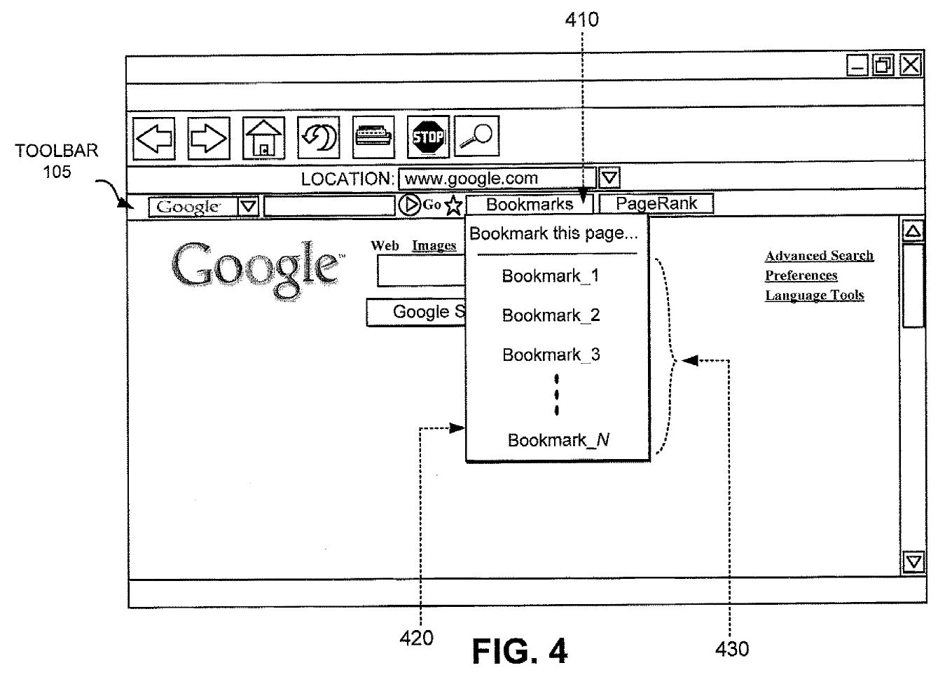

FIG. 4 is a diagram that depicts an exemplary browser toolbar 105 at a client 205. Among other features, toolbar 105 may include a “bookmark” button 410, the selection of which by a user at client 205 may produce a bookmark window 420. Bookmark window 420 may include a list of multiple bookmarks 430 associated with the user. The user, when browsing a given document, may select “Bookmark this page . . . ” from bookmark window 420 to add the Uniform Resource Locator (URL) of the given document as one of the bookmarks 430 in bookmark window 420. A bookmarked document may contain any type of document, such as, for example, images, products and/or services, music items, video items, etc. Bookmarks contained in the list of bookmarks 430 may be obtained by techniques other than the user browsing and “bookmarking” a respective document. Bookmarks contained in the list of bookmarks 430 may be obtained by importation of bookmarks from another browser, or via sharing of bookmarks between users. Sharing and importation of bookmarks is disclosed in co-pending U.S. application Ser. No. 11/327,644 (Attorney Docket No. 0026-0194), entitled “Server Bookmarks.”

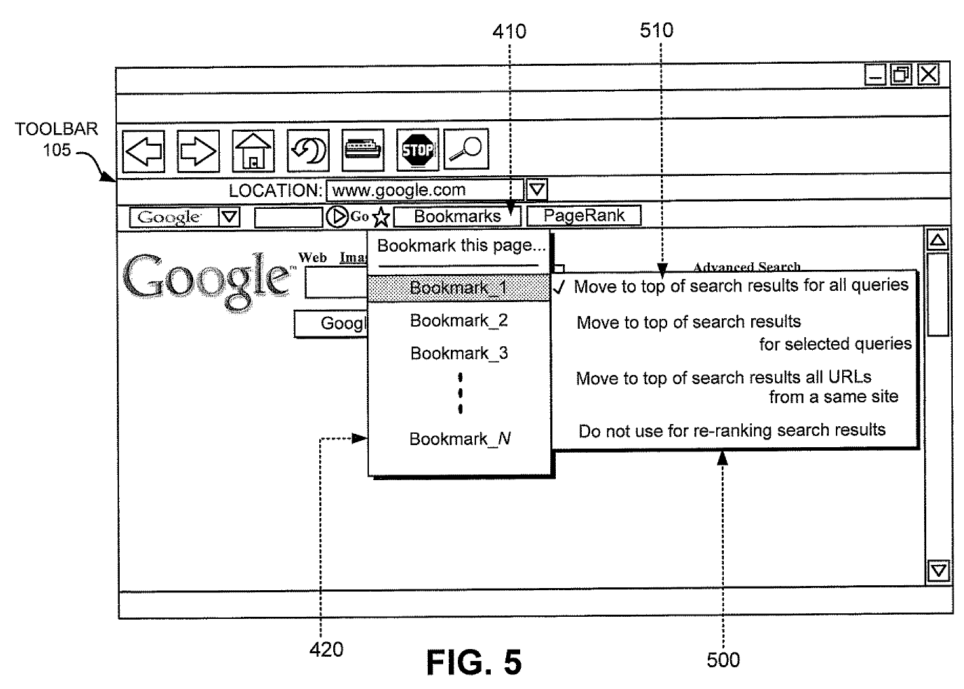

FIGS. 5-8 are diagrams that depict the use of browser toolbar 105 for specification of how and if a user's bookmarks may be used in ranking search results. As shown in FIG. 5, each bookmark may include an associated window 500 which permits the user to define how and if the selected bookmark will be used in ranking search results. FIG. 5 illustrates user selection of the option “Move to top of search results for all queries” 510 for bookmark_1 from window 500. Selection of this option 510, as shown in FIG. 5, by placement of a “check mark” next to it, directs server 230 to promote bookmark_1 upwards within a set of ranked search results.

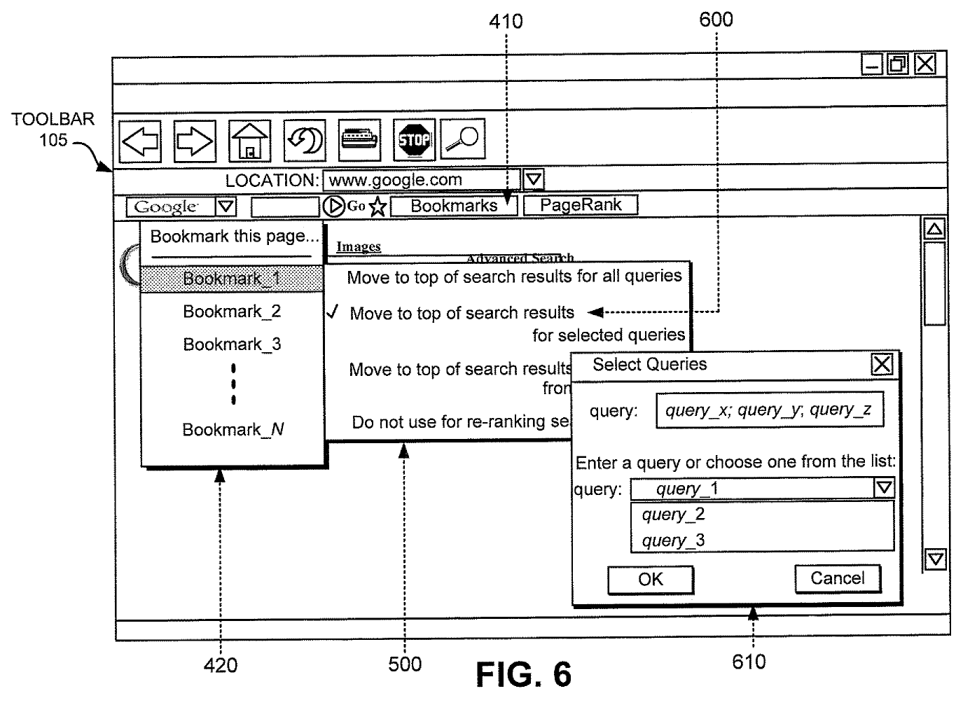

FIG. 6 illustrates user selection of the option “Move to top of search results for selected queries” 600 for bookmark_1 from window 500. Selection of this option 600, as shown in FIG. 6 by placement of a “check mark” next to it, in conjunction with user entry of a list of queries in window 610, directs server 230 to promote bookmark_1 upwards within a set of ranked search results that result from execution of a search using a search query that matches the queries entered in window 610. Thus, using this option, only when search engine 235 of server 230 executes a search on a search query that is the same, or possibly similar, to a set of search queries selected by the user does search engine 235 promote the corresponding given bookmark upwards within the ranked search results.

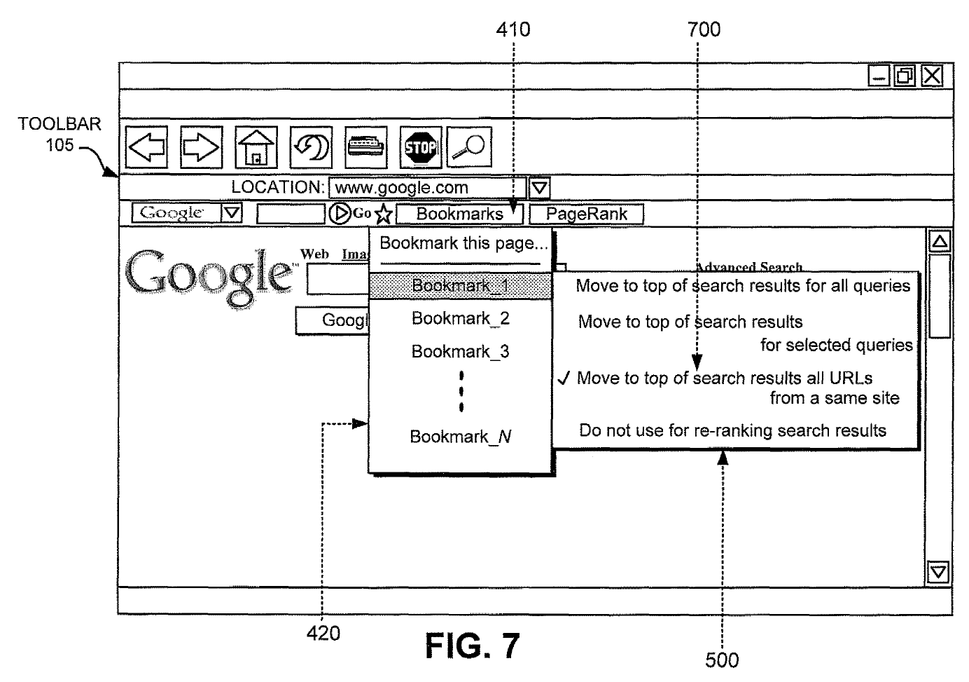

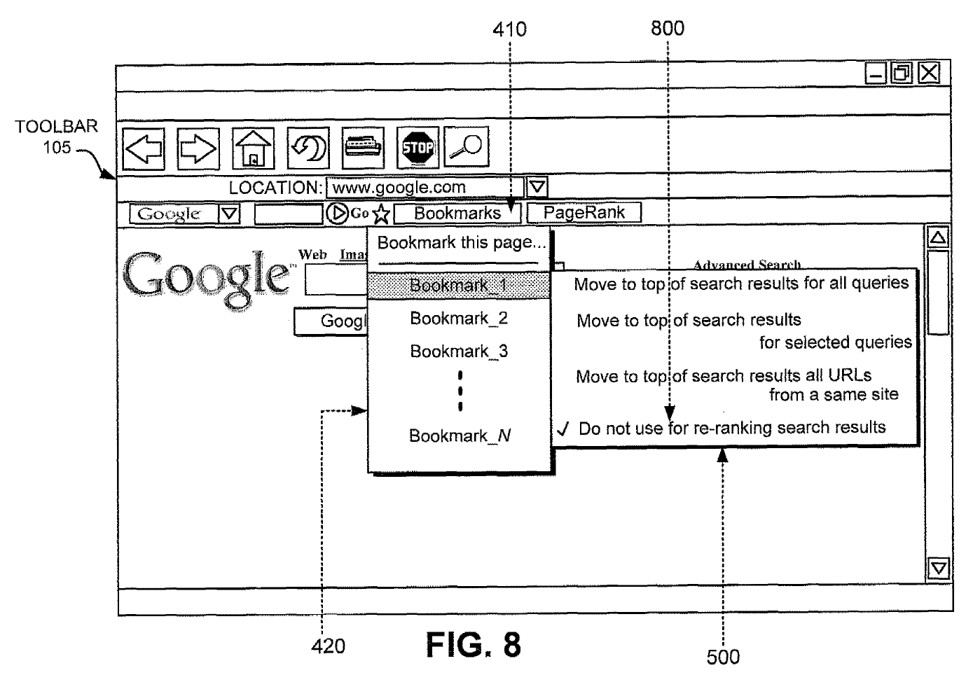

FIG. 7 illustrates user selection of the option “Move to top of search results all URLs from a same site” 700 for bookmark_1 from window 500. Selection of this option 700, as shown in FIG. 7 by placement of a “check mark” next to it, directs server 230 to promote bookmark_1, and all search results from a same site as bookmark_1, upwards within a set of ranked search results. Therefore, all documents hosted on the same site as bookmark_1 may be promoted within the search results. FIG. 8 illustrates user selection of the option “Do not use for re-ranking search results” 800 for bookmark_1 from window 500. Selection of this option 800, as shown in FIG. 8 by placement of a “check mark” next to it, directs server 230 to not promote bookmark_1 upwards within a set of ranked search results.

The user's specification of how and if a user's bookmarks may be used in ranking search results, as depicted above in FIGS. 5-8, may be sent from toolbar 105 to server 230 for storage in memory. For example, the user's specification may be stored in association with the user's entries in bookmarks records 240, described further below.

### Exemplary Bookmarks Records

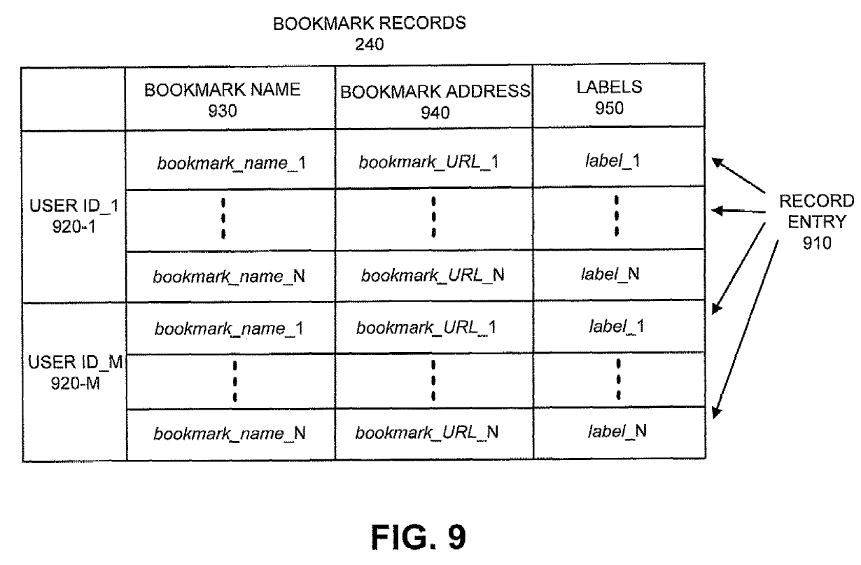

FIG. 9 illustrates exemplary bookmark records 240 consistent with principles of the invention. Bookmark records 240 may include bookmarks received at server 230 from one or more users at clients 205, with each user being identified by a different, unique user identifier 920-1 through 920-M. Bookmarks records 240 may, for example, be stored in a computer-readable medium associated with server 230. User ID 920 may include, for example, an Internet Protocol (IP) address associated with a user, a user log-in identifier, or any other type of unique data for identifying the user. As shown in FIG. 9, each user ID 920-1 through 920-M may have one or more record entries 910 associated with it. Each record entry 910 may include a bookmark name 930, a bookmark address 940, and one or more labels 950. Bookmark name 930 may include any name designated by the user for the particular bookmark. For example, if a user bookmarks the document www.google.com, the user may name the bookmark “Google.” Bookmark address 940 may include the address (e.g., URL) of the document bookmarked by the user. Labels 950 may include one or more different designated textual labels given by the user to the bookmark.

Each record entry 910 may further include data (not shown in FIG. 9) related to the user's specification of how and if a respective bookmark may be used in ranking search results. For example, each record entry 910 may include a flag entry indicating whether the “Move to top of search results for all queries” option 510, the “Move to top of search results for selected queries” option 600, the “Move to top of search results all URLs from a same site” 700 option, or the “Do not use for re-ranking search results” option 800 has been selected for a respective bookmark. If the “Move to top of search results for selected queries” option 600 has been selected, a corresponding record entry 910 may further include (not shown in FIG. 9) data corresponding to the search queries selected by the user.

### Exemplary Search Result Ranking Process

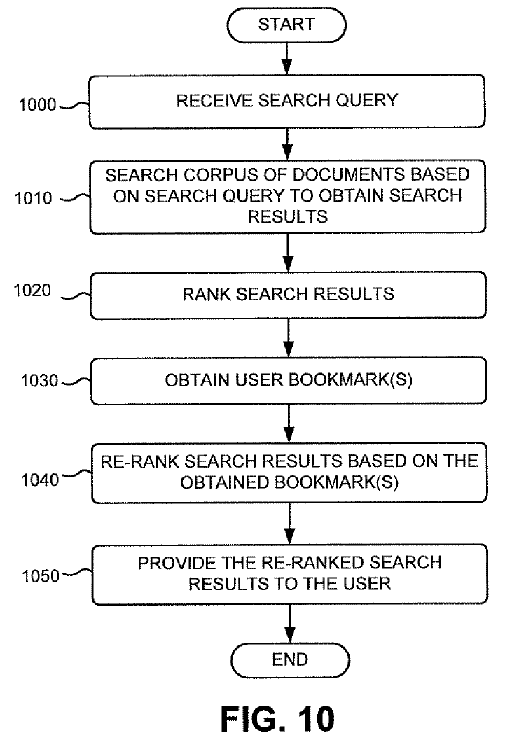

FIG. 10 is a flowchart of an exemplary process for ranking search results using user bookmarks consistent with principles of the invention. The process exemplified by FIG. 10 may be performed by server 230.

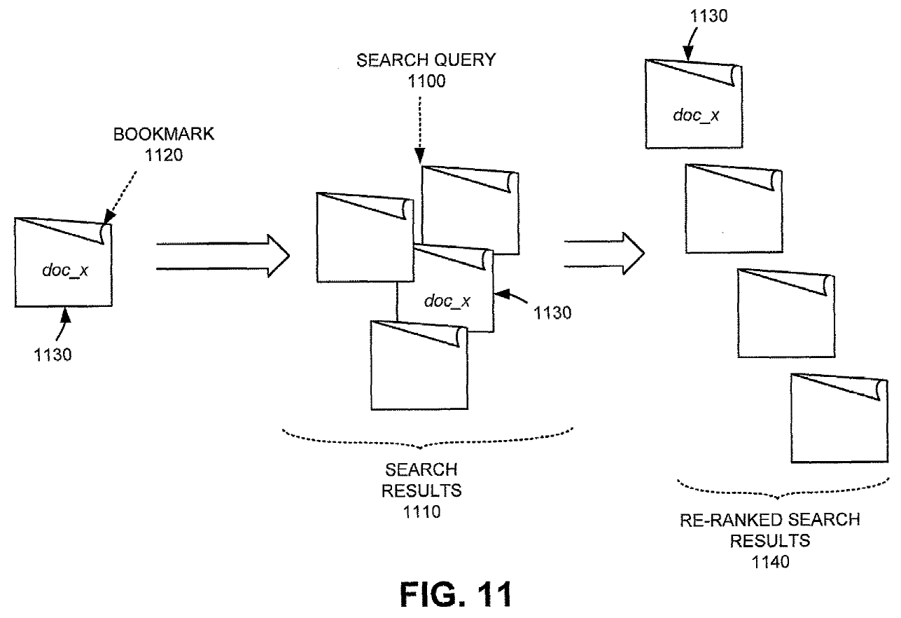

The exemplary process may begin with the receipt of a search query (block 1000)(FIG. 10). A user at a client 205 may send a search query to search engine 235 of server 230 via network 220. A corpus of documents may be searched based on the search query to obtain search results (block 1010). The corpus of documents may include, for example, a repository of documents crawled by server 230. Server 230 may use existing search techniques for searching the corpus of documents using the search query received from the user. FIG. 11 depicts an illustrative example in which search query 1100 is used to obtain a set of search results 1110. In addition to the corpus of documents, or instead of the corpus of documents, a corpus of bookmarks, that may include the user's bookmarks or other users' bookmarks (e.g., obtained as described below with respect to block 1030), may be searched. The search results resulting from the search may include bookmarks from the corpus of bookmarks.

The search results may be ranked in ranked order (block 1020). Server 230 may use existing ranking techniques for placing the documents of the search results in ranked order. For example, server 230 may order the search results based on a determination of the relevance of each of the search results to the search query. Those results that are more relevant to the search query may, thus, be ranked higher than less relevant results.

User bookmark(s) may be obtained (block 1030). Bookmarks associated with the user that sent the search query to server 230 may have been previously stored in bookmark records 240. Server 230 may retrieve the user's bookmarks from bookmark records 240. Server 230 may additionally retrieve, for each of the bookmarks, the corresponding indications received from the user that specify how and if a user's bookmarks should be used in ranking search results. As shown in FIG. 11, a bookmark 1120, associated with document 1130 may be obtained. Document 1130, as shown in FIG. 11, is also included in search results 1110. In some implementations, categorizations associated with the obtained bookmarks may also be determined. A given bookmark may have one or more categories associated with it. For example, a bookmark to a University of Nevada-Las Vegas Running Rebels web page may be associated with the category “NCAA Basketball,” and possibly other categories. In further implementations, host names or sites associated with a bookmark may also be obtained.

The search results may be re-ranked based on the obtained user bookmark(s) (block 1040). In one implementation, if documents corresponding to the user bookmark(s) are contained in the search results, then those documents may be promoted higher in the ranked search results relative to other of the search results. In other implementations, the user's specification, for each bookmark, may be used to determine how and if the user's bookmarks should be used in re-ranking the search results. For example, if the user had selected the “Move to top of search results for all queries” option for a given bookmark in window 500 of toolbar 105, then server 230 may promote the given bookmark upwards within the set of ranked search results. In further implementations, if documents corresponding to the category(ies) (determined in block 1030 above) associated with the user bookmark(s) are contained in the search results, then those documents may be promoted higher in the ranked search results relative to other of the search results. A document may correspond to a category(ies) associated with the user bookmark if it is determined to relate to the category(ies).

As another example, if the user had selected the option “Move to top of search results for selected queries” 600 for a given bookmark from window 500 of toolbar 105, then server 230 may promote the given bookmark upwards within a set of ranked search results that result from execution of a search using a search query that matches the queries that the user had entered in window 610. As yet another example, if the user had selected the “Move to top of search results all URLs from a same site” option 700 for a given bookmark from window 500 of toolbar 105, then server 230 may promote the given bookmark, and all other search results from a same site as the bookmark, upwards within the set of ranked search results. As a further example, if the user had selected the “Do not use for re-ranking search results” option 800 for a given bookmark from window 500 of toolbar 105, server 230 may not promote the given bookmark upwards within the set of ranked search results. In the illustrative example of FIG. 11, document 1130, associated with bookmark 1120, is ranked first among the re-ranked search results 1140.

The re-ranked search results may be provided to the user (block 1050). For example, the ranked search results may be placed in rank order in a document and sent to the user at client 205 via network 220.

### Conclusion

The foregoing description of implementations consistent with principles of the invention provides illustration and description, but is not intended to be exhaustive or to limit the invention to the precise form disclosed. Modifications and variations are possible in light of the above teachings, or may be acquired from practice of the invention. For example, while a series of acts have been described with regard to FIG. 10, the order of the acts may be modified in other implementations consistent with the principles of the invention. Further, non-dependent acts may be performed in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects have been described without reference to the specific software code, it being understood that one of ordinary skill in the art would be able to design software and control hardware to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving bookmarks associated with one or more documents or sites;
searching a corpus of documents to obtain search results; and
ranking the search results using the received bookmarks.

2. The method of claim 1, wherein the corpus of documents include a corpus of bookmarks.

3. The method of claim 2, wherein the corpus of bookmarks includes the received bookmarks.

4. The method of claim 1, farther comprising:
determining one or more categories associated with the received bookmark, wherein ranking the search results includes using the one or more categories to rank the search results.

5. The method of claim 1, wherein ranking the search results comprises:
promoting ones of the search results that correspond to the one or more categories within the ranked search results.

6. The method of claim 1, wherein the bookmarks identify documents browsed by a user at a client.

7. The method of claim 1, further comprising:
providing the ranked search results to a user associated with the bookmarks.

8. The method of claim 1, wherein ranking the search results using the received bookmarks comprises:
promoting ones of the search results that correspond to the received bookmarks within the ranked search results.

9. The method of claim 1, further comprising:
receiving a selection of a bookmark from the bookmarks to promote a document that corresponds to the selected bookmark among other of the search results when ranking the search results.

10. The method of claim 1, wherein searching the corpus of documents to obtain search results comprises:
searching the corpus of documents based on a first search query; and
further comprising:
receiving a selection of a bookmark from the bookmarks and a second search query,
wherein ranking the search results comprises promoting a document that corresponds to the selected bookmark among the search results when the second query matches the first query.

11. The method of claim 1, further comprising:
receiving a selection of a bookmark from the bookmarks,
wherein ranking the search results comprises:
promoting a document that corresponds to the selected bookmark, and documents associated with the same site as the selected bookmark, among the search results.

12. The method of claim 1, further comprising:
receiving a selection of a bookmark from the bookmarks and an indication that the selected bookmark should not be used in ranking the search results,
wherein ranking the search results comprises:
ranking the search results without promoting a document, that corresponds to the selected bookmark, among the search results based on the indication.

13. A method, comprising:
receiving bookmarks associated with one or more documents or sites:
receiving user input defining how or if the bookmarks are to effect search results;
searching a corpus of documents to obtain search results; and
ranking the search results using the bookmarks based on the user input.

14. The method of claim 13, further comprising:
providing the ranked search results to a user that initiated the search.

15. The method of claim 13, wherein receiving user input defining how or if the bookmarks are to effect search results comprises:
receiving a selection of a bookmark from the bookmarks to promote among other of the search results when ranking the search results.

16. The method of claim 13, wherein receiving user input defining how or if the bookmarks are to effect search results comprises:
receiving one or more search queries and a selection of a bookmark from the bookmarks to promote among other of the search results when ranking the search results obtained from a search using the one or more search queries.

17. The method of claim 13, wherein receiving user input defining how or if the bookmarks are to effect search results comprises:
receiving a selection of a bookmark of the bookmarks to promote, along with documents associated with the same site as the selected bookmark, among other of the search results when ranking the search results.

18. The method of claim 13, wherein receiving user input defining how or if the bookmarks are to effect search results comprises:
receiving a selection of a bookmark of the bookmarks and an indication that that bookmark is not to be promoted among other of the search results when ranking the search results.

19. A method, comprising:
obtaining a user's bookmarks, wherein the bookmarks identify documents selected by the user;
executing a search based on a first search query received from the user to obtain search results;
ranking the search results; and
re-ranking the search results using the user's bookmarks.

20. The method of claim 19, wherein the bookmarks identify documents selected or browsed by the user.

21. The method of claim 19, further comprising:
providing the re-ranked search results to the user.

22. The method of claim 19, wherein re-ranking the search results using the user's bookmarks comprises:
promoting ones of the search results that correspond to the user's bookmarks within the ranked search results.

23. The method of claim 19, further comprising:
receiving a selection of a bookmark from the user's bookmarks to promote among other of the search results when re-ranking the search results.

24. The method of claim 19, further comprising:
receiving a selection of a bookmark from the user's bookmarks and a second search query, wherein re-ranking the search results comprises promoting the selected bookmark among the search results when the second search query matches the first search query.

25. The method of claim 19, further comprising:
receiving a selection of a bookmark from the user's bookmarks,
wherein re-ranking the search results comprises:
promoting the selected bookmark, and documents associated with the same site as the selected bookmark, among the re-ranked search results.

26. The method of claim 19, further comprising:
receiving a selection of a bookmark of the user's bookmarks,
wherein re-ranking the search results comprises:
re-ranking the search results without promoting the selected bookmark among the search results.

27. A system, comprising:
means for obtaining bookmarks associated with one or more documents or sites;
means for searching a corpus of documents to obtain search results; and
means for ranking the search results using the received bookmarks.

28. A computer-readable medium that stores computer-executable instructions, comprising:
instructions for obtaining bookmarks associated with one or more documents or sites:
instructions for receiving user input defining how or if the bookmarks are to effect search results;
instructions for searching a corpus of documents to obtain search results; and
instructions for ranking the search results using the bookmarks based on the user input.
